(19) United States
(12) Patent Application Publication
(10) Pub. No.: US 2004/0139274 A1
(43) Pub. Date: Jul. 15, 2004

(54) Virtual content addressable memory with high speed key insertion and deletion and pipelined key search

(76) Inventor: Ronald Chi-Chun Hui, Hong Kong (HK)

Correspondence Address: SWIDLER BERLIN SHEREFF FRIEDMAN, LLP, 3000 K STREET, NW, BOX IP, WASHINGTON, DC, 20007, US

(21) Appl. No.: 10/687,775

(22) Filed: Oct. 20, 2003

Related U.S. Application Data
(60) Provisional application No. 60/419,571, filed on Oct. 21, 2002.

(51) Int. Cl. G06F 12/00

(52) U.S. Cl. 711/108; 711/159

(57) ABSTRACT

A content addressable memory is implemented as a memory with a L-level hierarchy. When accessing the memory, key data is compared at each level of the hierarchy to determine whether an exact match, a longest prefix match exists. The CAM may be implemented with a two level hierarchy and a memory configuration that stores keys in cyclical ascending or cyclical descending order. Each memory row may include row logic to create the first level hierarchical data directly from its row data. The row data itself comprises the second level hierarchical data. During the search process, the key data is compared to the first level hierarchical data which narrows the search to only particular memory rows for the exact match or longest prefix match operation. This architecture is fast, power efficient and makes efficient use of transistors. Additional row logic and a dual port memory implementation permits the insertion and deletion of key elements into and from rows in a single parallel operation that maintains the cyclical ascending or descending order of key elements in the rows rather than multiple operations.

### CROSS REFERENCE TO RELATED APPLICATIONS

This application claim priority to prior provisional patent application No. 60/419,571 filed on Oct. 21, 2002 and entitled “Virtual Content Addressable Memory With High Speed Key Insertion And Deletion And Pipelined Key Search.”

### FIELD OF THE INVENTION

The present invention relates generally to content addressable memories and, more particularly, to a method and memory architecture for implementing a virtual content addressable memory that performs high speed key insertion and deletion and pipelined key searching.

### BACKGROUND OF THE INVENTION

Content addressable memory (“CAM”) is a type of computer memory, implemented in a chip, that allows stored data to be accessed by its association with other data known as key data. The key data may be, for example, a person's name and the data associated with the key data may be, for example, the person's telephone number. When retrieving stored data from a CAM, the key data is used as the address for accessing the memory and the data associated with the key data. For example, when determining a person's telephone number, the person's name is used as the address or key data for the memory search and the person's telephone number is returned if present in memory.

CAM is different from conventional memory. Conventional memory stores data at sequentially numbered memory address locations. The address locations are unrelated to the memory contents. For this reason, when a conventional memory stores data such as the names of people and their telephone numbers, software and the processor chip are required to search the entire memory sequentially until the name is found in order to determine the telephone number. Therefore, the search and retrieval process for conventional memory is much more slow than for CAM.

Despite their high speed operation, CAM chips have significant drawbacks as compared to conventional memory chips. For this reason, their use is much less common that conventional memory. CAMs require much more logic than conventional memories. For example, with current technologies, CAM uses 12-15 transistors per bit of memory whereas conventional memory uses 6 transistors per static random access memory (“SRAM”) bit. The extra bits are required by conventional CAM technologies to implement comparator logic for each bit of memory to facilitate the search and retrieval process. These extra transistors also cause conventional CAM chips to consume an order of magnitude more power than convention memory chips. For example, a typical 18M-bit CAM chip uses 10 W of power while a 18M-bit SRAM chip may use less than 1 W of power. Another significant drawback of CAM is that it has significantly less memory capacity per chip than conventional memory because of the extra transistors required per bit.

Notwithstanding all of the drawbacks of CAM, search and retrieval of data in CAM chips is so much faster than conventional memory chips that it must be used for certain applications that require fast search and retrieval. One example of applications that generally must use CAMs are network switches that perform packet classification and switching at high speeds. Packet classification and switching requires frequent search and retrieval of data from memory at speeds approaching the access time for searching a single or a few memory locations of a conventional memory. For other applications, CAM would be desirable to use but, because of all of its drawbacks as compared to conventional memory, it is not used.

Accordingly, there is a need for CAM chips that provide the benefits of CAM without the significant drawbacks associated with conventional CAM. There is a further need for CAM chips that dissipate less power and have faster storage and retrieval speeds as compared to conventional CAMs. There is a need further need for CAMs that may be implemented in higher capacities per chip than conventional CAMs.

### SUMMARY OF THE INVENTION

According to the present invention, a content addressable memory is implemented as a memory with an N-level hierarchy. When accessing the memory, key data is compared at each level of the hierarchy to determine whether an exact match, a longest prefix match, and/or a range match exists. According to one embodiment of the invention, the CAM is implemented as a two level hierarchy with a memory configuration that stores keys in cyclical ascending or cyclical descending order in a dual port RAM configuration. Each memory row includes row logic to create the first level hierarchical data directly from its row data. The row data itself comprises the second level hierarchical data. During the search process, the key data is compared to the first level hierarchical data which narrows the search to only particular memory rows for the exact match, longest prefix match and/or range match operations. This architecture is fast, power efficient and uses few extra transistors. Additional row logic and a dual port memory implementation permits the insertion and deletion of key elements into and from rows in a single parallel operation that maintains the cyclical ascending or descending order of key elements in the rows rather than multiple operations.

According to one embodiment of the present invention, a content addressable memory finds data associated with key data and includes memory, an update block and at least one search block. The memory has a L level hierarchy for storing key entries in a sorted tree form where L>1. The memory also stores data associated with the key entries or pointers to the associated data. The update block inserts new key entries and associated data into the memory and deletes key entries and associated data from the memory, while maintaining the sorted tree form of the key entries. The search block identify a key entry and associated data that match the key data based on comparisons between the received key data and the key entries in the memory at each level of the hierarchy.

The search blocks may include L search blocks, where each search block corresponds to a memory level. Each search block may returns an address value that identifies a subset of the next level of the memory for the search operation of the lower level search block until a matching entry or lack thereof is identified by the lowest level search block. According to one embodiment of the invention, the search blocks may be arranged as a pipeline to receive new key data for search and retrieval operations in successive memory cycles. The search blocks may be configured to determine an exact match or a longest prefix match. The longest prefix match may be determined by masking the key data and key entries for different prefix lengths, determining when an exact match exists for different prefix lengths and selecting the longest exactly matching prefix.

The memory may include rows of key entries arranged in order of key value. The memory may store the key entries in cyclical ascending or cyclical descending order. Moreover, the memory may include pointers to a maximum and a minimum value of each memory row. The memory may also store a node value for each row that represents each row as a key entry in a higher level of the memory hierarchy. According to one embodiment of the present invention, the node value may be the maximum value for each row.

The update block may store key entries displaced by insertion of a new key into the maximum value position of the next sequential row. The update block may subsequently update the maximum and minimum value pointers of the next row based on the displacement. Similarly, the update block may store key entries displaced by deletion of a key entry into the minimum value position of the deletion row. The update block may updates the maximum and minimum value pointers of the deletion row based on the displacement. The memory may be implemented as a dual port random access memory that performs key entry insertion and deletion in three sequential operations performed in parallel.

According to another embodiment of the present invention, a method is used to find data associated with key data in a content addressable memory. According to the method, data is stored in a memory having a L level hierarchy for storing key entries in a sorted tree form where L>1. The memory also stores data associated with the key entries or pointers to the associated data. Each level of the L level memory is searched based on the key data. Then a key entry is identified that matches the key data based on the searching at each level of the L level memory hierarchy. The associated data may be retrieved based on the matching key entry identified. The identification may be made as an exact match or a longest prefix match.

The memory may include rows for storing key entries in order of value and maximum and minimum pointer values for each row. New key entries may be inserted into the memory at an insertion row that is determined based on the value of the key entry. A key entry that is displaced out of the insertion row may be moved into the maximum value position of the next sequential row, after which the maximum and minimum value pointers of the insertion row are updated based on the displacement. Similarly, key entries and associated data may be deleted from the memory by deleting a key entry in a deletion row. This operation may displace key entries stored elsewhere in memory. As part of the displacement, a key entry from the next sequential row may be stored into the minimum value position of the deletion row. Then, the maximum and minimum value pointers of the deletion row may be updated based on the displacement.

### BRIEF DESCRIPTION OF THE FIGURES

FIG. 1 depicts a block diagram of a L level virtual content addressable memory (VCAM) according to an embodiment of the present invention.

FIG. 2 depicts a block diagram of a memory implementation for a two level VCAM illustrating entry insertion according to an embodiment of the present invention.

FIG. 3 depicts a method of inserting a new key entry into a VCAM according to an embodiment of the present invention.

FIG. 4 depicts a dual port memory layout for a VCAM according to an embodiment of the present invention.

FIG. 5 depicts a block diagram of a memory implementation for a two level VCAM illustrating memory deletion according to an embodiment of the present invention.

FIG. 6 depicts a method of deleting a new key entry into a VCAM according to an embodiment of the present invention.

FIG. 7 depicts a block diagram of a search operation based on a two level VCAM according to an embodiment of the present invention.

FIG. 8 depicts a method of performing a search operation for a VCAM according to an embodiment of the present invention.

FIG. 9 depicts a block diagram of a search block according to an embodiment of the present invention.

FIG. 10 depicts an illustrative implementation of the prefix match unit according to an embodiment of the present invention.

FIG. 11 depicts an illustrative implementation of a prefix group unit used in determining a longest prefix match according to an embodiment of the present invention.

FIG. 12 depicts an illustrative implementation of a range match unit according to an embodiment of the present invention.

### DETAILED DESCRIPTION

According to the present invention, a content addressable memory is implemented as a memory with an N-level hierarchy. When accessing the memory, key data is compared at each level of the hierarchy to determine whether an exact match, longest prefix match and/or a range match exists. According to one embodiment of the invention, the CAM is implemented as a two level hierarchy with a memory configuration that stores keys in cyclical ascending or cyclical descending order in a dual port RAM configuration. Each memory row includes row logic to create the first level hierarchical data directly from its row data. The row data itself comprises the second level hierarchical data. During the search process, the key data is compared to the first level hierarchical data which narrows the search to only particular memory rows for the exact match, longest prefix match and/or range match operations. This architecture is fast, power efficient and makes efficient use of transistors. Additional row logic and a dual port memory implementation permits the insertion and deletion of key elements into and from rows in a single parallel operation that maintains the cyclical ascending or descending order of key elements in the rows rather than multiple operations.

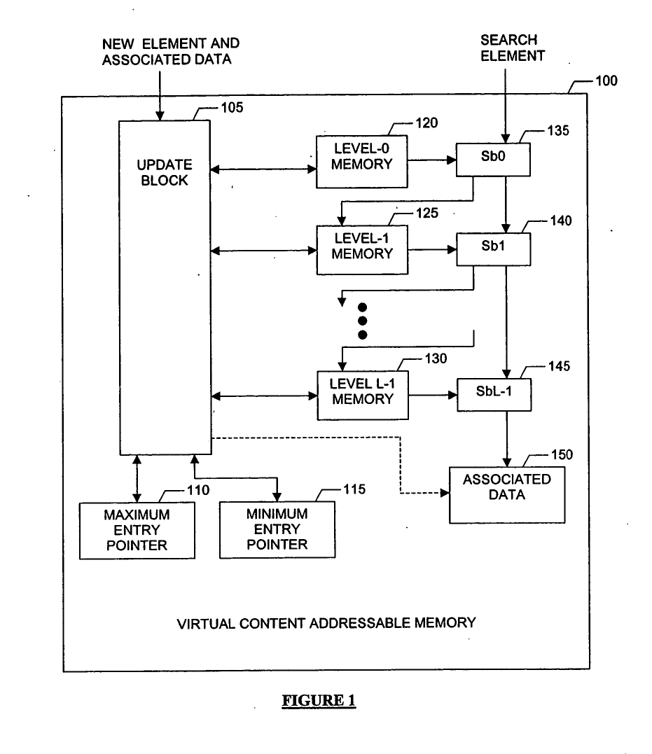

FIG. 1 depicts a block diagram of a L level virtual content addressable memory (VCAM) according to an embodiment of the present invention. Referring to FIG. 1, the memory 100 includes an update block 105, pointers 110 and 115, L levels of memory 120-130, L search blocks 135-145 and an associated data memory 150.

The memories 120-130 store key data corresponding to associated data in the associated data memory 150. According to one embodiment of the present invention, the key data is arranged into the memory hierarchically so that it maintains a sorted tree structure and so that the memory may be searched using a binary tree search algorithm. For example, the memories 120-130 may be arranged into L memories or memory portions, each associated with a different level within a L level sorted tree. Each level has at least one node represented by a key element that has sorted tree properties relative to the lower levels. Specifically, each node may have D child nodes that are each represented by a key element that has sorted tree properties relative to the lower levels. At any given memory level, the number of nodes may be equal to the number of nodes in level 0*D^{L}.

The stored tree property may be described as follows. Each node has an entry or node value that represents the entries of its child nodes of lower level. The node value may be the maximum value of the child node values, the minimum value of the child node values, the middle value of the child node values or a representation that relates in any convenient way to the child node values. For any two nodes that are one the same level, the two nodes can be given arbitrary designations of node index i and node index j, so that the entry at index i is less than the entry at index j. In other words eᵢ<eⱼ. When the condition eᵢ<eⱼ is met, then eᵢ<the value of all of the child node entries of node j. In addition, each child node entry of node i will be smaller than eⱼ and all of the child node entries of node j.

The update block 105 receives new elements and associated data for storage into the VCAM 100. The update block 105 stores each new element into the memories 120-130 in such a way that the sorted tree structure associated with the memories 120-130 is maintained. According to one embodiment of the invention, the update block 105 maintains the sorted tree structure in the memory 120-130 by storing each new element into the lowest level of memory (L−1) in an indexed fashion such that the lowest level memory maintains all of the entries in cyclical ascending or cyclical descending order. Any ordinal storage scheme may be used, however. The higher levels of memory, levels 0−(L−2), may be updated automatically during the process of inserting a new entry into the lowest level of the memory 130.

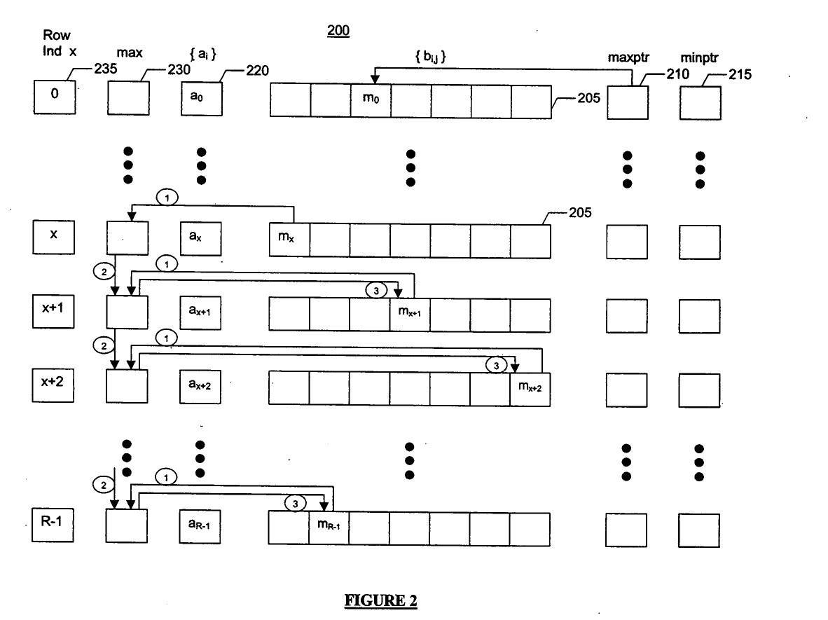

The maximum entry pointer 10 and the minimum entry pointer 1115 may be used as pointers to multiple portions of the memories 120-130 and are used during the processes of inserting and deleting elements from the memories. In particular, the pointers may be used to identify portions of the memory into which data should be shifted to accommodate a newly inserted element or a newly deleted element in order to maintain the proper order of key elements stored in the memories 120-130. An embodiment for inserting and deleting elements using the pointers 110 and 115 is shown and described with reference to FIGS. 2-5.

By maintaining the sorted tree structure of the memories 120-130, the search blocks 135-145 may be implemented to efficiently search the L level memory hierarchy for search and retrieval operations. Each search block at a particular level receives the key values to be searched against from the key elements stored in memory associated with that level. There may be one or more key elements stored and searched against at each level. At the level 0 search block 135, the search block receives the key data for searching and compares the value to the entries in the level 0 memory 120.

The search block Sb0 outputs an entry index i, such that eᵢ<input key<e₊₁ within the level 0 memory. The value e₁ represents the value of the entry having an index i. The entry index i may also a match index that identifies a range match within the level memory. The entry index or address value output from search block Sb0 is then carried forward to each subsequent search block level.

The address values from previous levels are concatenated and yield a search address value that identifies the child nodes within the corresponding memory level with which to compare the key data being searched. Each comparison returns a range match index i such that eᵢ<input key<eᵢ₊₁. The index is concatenated with the addresses already generated at each higher level search block. The output of the last search block is an address value that represents an address value of the memory entry that matches the key data if certain conditions are met. The address value may be used as a pointer to the memory and/or the associated data memory 150 to retrieve the data associated with the key data being searched.

The associated data memory 150 stores the associated data received from the update block with each new entry. The associated data may be stored in the same memory location as its associated key entries, may be stored in a separate memory location with its pointer value stored in association with the key entry data or in any other convenient manner.

Two Level Hierarchical Implementation Using A Dual Port Ram

FIG. 2 depicts a block diagram of a memory implementation for a two level VCAM illustrating entry insertion according to an embodiment of the present invention. Referring to FIG. 2, the memory 200 is arranged into rows 205. Each row includes key entries bᵢⱼ where i represents the memory row and j represents the memory column for the element data. Each row is arranged in cyclical ascending or cyclical descending order such that for any given row i, b_{i,j}>b_{i,j+1} or b_{i,j}<b_{i,j+1} where the starting point j is determined by the maximum pointer or minimum pointer depending on whether the row is arranged in cyclical ascending or descending order. In addition, b_{i,j}<b_{i+1,j} or b_{i,j}>b_{i+1,j} for all j depending on whether the array is arranged in cyclical ascending or descending order.

Another way to explain cyclical ascending order is as follows. Each row stores key entries such that the row has a minimum value and a maximum value. The maximum value of a given row is smaller than the maximum value of all rows “below” the given row. In addition, the maximum value of a given row is higher than the maximum value of all rows “above” the given row.

Within a given cyclically ascending row, the key entry values are arranged so that they are positioned one next to the other in increasing order of value beginning with the minimum value and ending with the maximum value of the given row. The minimum value, however, may not occupy the left most position of the row and the maximum value may not occupy the right most position of the row, or vice versa. Rather, the maximum and minimum pointer values determine these arbitrary positions for a given row. Then, the entry values are arranged on the row so that they increase in value from left to right beginning with the minimum value position. When the values reach the right end of the row, they wrap around are stored beginning at the left most position of the row and continuing to the right in order of increasing values until the maximum value position is reached. The maximum value position is identified by the maximum value pointer and stores the maximum value for the row. Rather than right to left, the order may arbitrarily be set to left to right and of course top to bottom or bottom to top depending on how the memory is arbitrarily configured and designated.

Cyclical descending order is the same as cyclical ascending order except that the entry values are arranged into positions by decreasing order of value. Therefore, higher rows have lower key entry values for cyclical descending order implementations.

The maximum pointer and minimum pointer values 210 and 215 respectively point to the maximum and minimum values on each row of the memory 200. The aᵢ column labeled 220 stores the maximum value associated with each row i of the memory 200. The value stored in the register or memory location 220 is kept current for each row by the update logic. The update value stored in the column 230 represents either the maximum value or the minimum value of each row depending on whether an increment or decrement operation is being performed by the update logic and whether the key elements are arranged in cyclical ascending or cyclical descending order. In addition, the update value may represent only a subset of key entries that are being rearranged due to an insertion or deletion of an element within the array of elements b_{i,j}. The row index 235 may or may not be used by the update logic and is shown in FIG. 2 for convenience of labeling.

1. Insertion

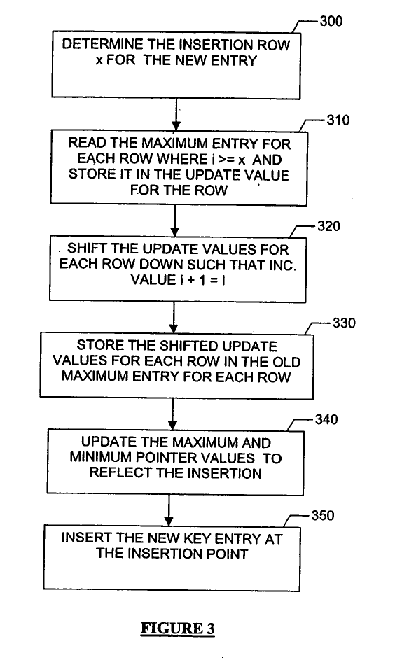

FIG. 3 depicts a method of inserting new key data into the memory shown in FIG. 2. The method and description illustratively describe an example where data is stored in the memory bᵢⱼ in a cyclical ascending implementation. However, it will be understood that the method is equally applicable to cyclical descending and other ordinal implementations of b_{i,j}. The method of FIG. 3 also functionally describes an embodiment of the update block 105.

Referring to FIG. 3, the update logic 105 receives new data for insertion into the memory and determines the point of insertion for the new data. The point of insertion may be determined by performing a range search operation as described with reference to FIGS. 7-9 using the search blocks 135-145. The row where the insertion is determined to be at is shown as row x in FIG. 2. Then in step 310, the update logic reads the maximum entry for each row 205 that has key entries in it where the row index i>=x and stores it in the update value 230 for the row. The rows where the row index i>=x are those rows affected by the insertion of a new key entry when rows are arranged in cyclical ascending order. This is because inserting a new entry displaces all higher valued entries by one position. The higher valued entries, by definition, are stored in rows where the row index i>x. There also may be entries on the insertion row x that have a higher value than the inserted key entry which are also displaced by one position as well.

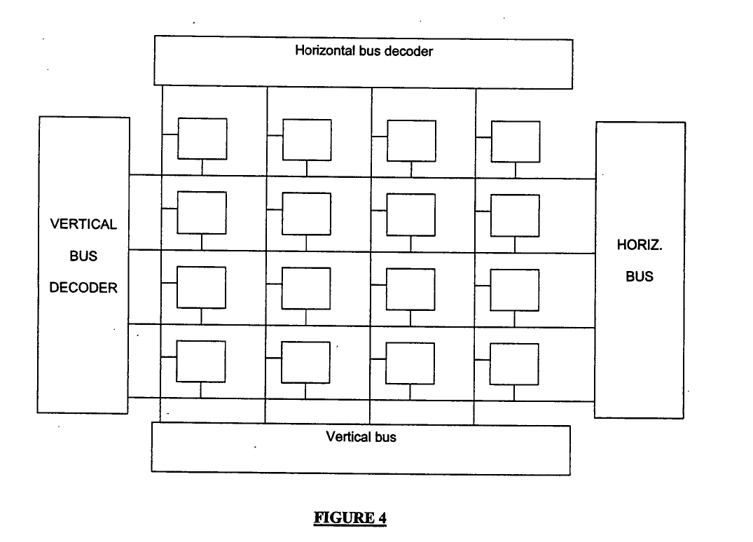

When the memory array that stores b_{i,j} is implemented as a dual port RAM, the insertion operation may be performed in parallel for all of the rows by reading the maximum value in each row over the horizontal bus and storing the maximum values for rows where the row index i>x until the last row with valid data in the update value registers for the corresponding row. The maximum value for each row is pointed to by the max pointer value 210. The horizontal bus used to implement the parallel maximum value operation is shown in FIG. 4. The operation is also graphically depicted in FIG. 2 which shows the maximum values m, being stored in a first operation in parallel into the update values for the row. It is apparent from looking at the rows that the maximum value may be stored in any column of each row because the data are arranged in cyclical order.

In step 320, the update values 230 are shifted downward for each row beginning with row x, the point of insertion, and ending with row R-1, which is the last row with valid key entries. This operation may be performed for all of the rows in parallel using the horizontal bus shown in FIG. 4. This operation is graphically depicted in FIG. 2 with the operation designated with the label 2.

In step 330, the update logic stores the maximum values for each row in the old maximum entry value for each row i where i>x. This operation is graphically illustrated in FIG. 2 with the arrows labeled 3. This operation may be performed in parallel over the horizontal bus by inserting each value stored in the update value register for the row into row location specified by the maximum pointer 210 for that row. In effect what is happening in this step is the maximum value from the higher row is being stored as the lowest value of next row. The lowest value is being written into the old maximum value location of each row, which is no longer valid because this value has been displaced to the lowest value entry of the next row.

In step 340, the update logic updates the maximum and minimum value pointers to reflect the new maximum value location on the row. This update may involve adding or subtracting one column memory location to or from the pointers. In effect what is happening in this step is the maximum value pointer is being changed to specify what was the second highest value of the row prior to the insertion as the new maximum value for the row. This operation is performed for rows>x in the memory that have valid data. The new maximum value is right next to the new minimum value which is the old maximum value location in the row. The minimum value pointer is updated to reflect this.

In step 350, the new key entry is stored in row x at the insertion point by reading row entries over the vertical bus, shifting the entries in the direction of ascending order and writing the shifted data back over the vertical bus to the row x with the new key data being inserted in the proper order on the row.

2. Deletion

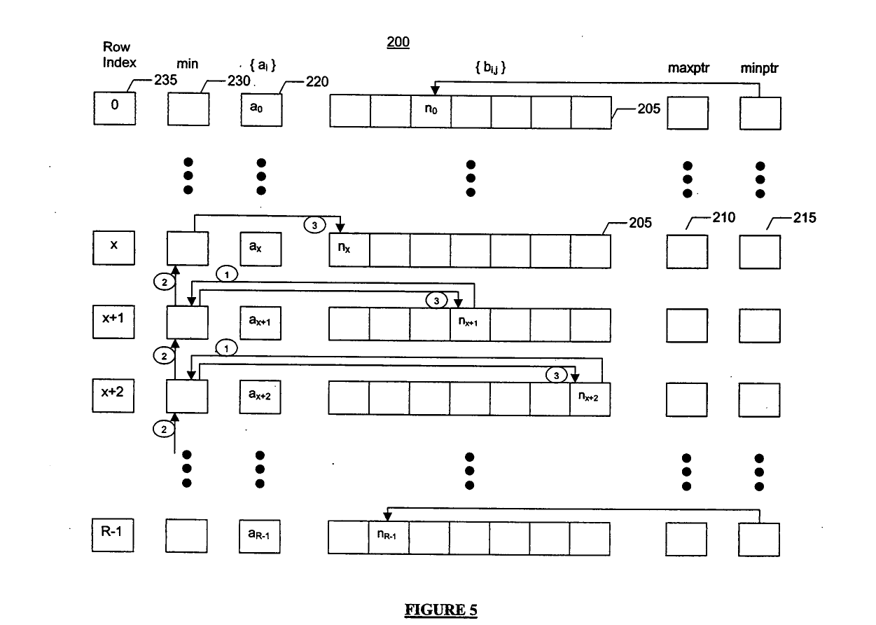

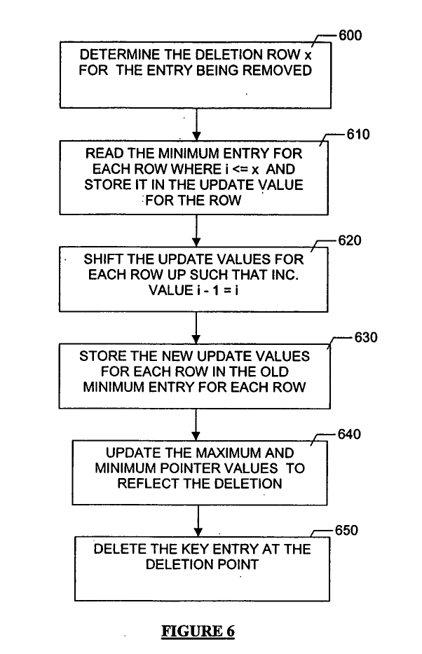

FIG. 6 depicts a method of inserting new key data into the memory shown in FIG. 5. The memory shown in FIG. 5 is the same as that shown in FIG. 2. The method and description illustratively describe an example where data is stored in the memory bᵢⱼ in a cyclical ascending implementation. However, it will be understood that the method is equally applicable to cyclical descending and other ordinal implementations of b_{i,j}. The method of FIG. 6 also functionally describes an embodiment of the update block 105.

Referring to FIG. 6, in step 600 the update logic 105 receives the identity of a key entry for deletion from the memory and determines the point of deletion for the new data. The point of deletion may be determined by performing a range search operation as described with reference to FIGS. 7-9 using the search blocks 135-145. The row where the deletion is determined to be at is shown as row x in FIG. 5. Then in step 610, the update logic reads the minimum entry for each row 205 that has key entries in it where the row has a row index i>x. The update logic stores the minimum value in the update value register 230 for the row.

When the memory array that stores b_{i,j} is implemented as a dual port RAM, this operation may be performed all at once in parallel for all of the rows by reading the minimum value in each row over the horizontal bus and storing the minimum values for rows where i>x in the update value registers for each corresponding row. The minimum value for each row is pointed to by the min pointer value 215. The horizontal bus used to implement the parallel minimum value operation is shown in FIG. 4. The operation is also graphically depicted in FIG. 5 which shows the minimum values n, being stored in a first operation in parallel into the update values for the row. It is apparent from looking at the rows that the minimum value may be stored in any column of each row because the data are arranged in cyclical order.

In step 620, the update values 230 are shifted upward for each row beginning with row x+1, one greater than the insertion row, and continuing for each row having a row index i>x and valid entry data. This operation may be performed for all of the rows in parallel using the horizontal bus shown in FIG. 4. This operation is graphically depicted in FIG. 5 with the operation designated with the label 2.

In step 630, the update logic stores the new update values for each row in the old minimum entry value for each row i where i>x. This operation is graphically illustrated in FIG. 5 with the arrows labeled 3. This operation may be performed in parallel over the horizontal bus by inserting each value stored in the update value register for the row into row location specified by the minimum pointer 210 for that row. In effect what is happening in this step is the minimum value from the lower row is being stored as the maximum value of the higher. The lowest value is being written into the old lowest value location of each row, which is no longer valid because this value has been displaced to the highest value entry of the next row.

In step 340, the update logic updates the maximum and minimum value pointers to reflect the new minimum value location on the row. This update may involve adding or subtracting one column memory location to or from the pointers. In effect what is happening in this step is the minimum value pointer is being changed to specify what was the second lowest value of the row prior to the insertion as the new minimum value for the row. This operation is performed for rows having valid data in memory and a row index i>x. The new maximum value is right next to the new minimum value which is the old minimum value location in the row. The minimum value pointer is updated to reflect this.

In step 350, the key entry is deleted from the row x at the deletion point by reading row entries over the vertical bus, shifting the entries in the opposite direction of ascending order and writing the shifted data back over the vertical bus to the row x with the key data deleted.

3. Search and Retrieval

FIG. 7 depicts a block diagram of a search operation based on a two level memory implementation according to an embodiment of the present invention. Referring to FIG. 7, the memory includes level 0 memory 700 and level 1 memory 710. The level 0 memory 700 is shown to illustratively include three key entries 40, 80 and 120. The level 1 memory 710 is shown to include D^{L-1} key entries*the number of entries in level 0 memory. Since D=3 and L=2, and there are four entries in level 0 memory, there are twelve key entries in the level 1 memory 700. Each of the key entries in level 1 memory 710 is part of a node that comprises D, or 3, elements. The nodes are shown in FIG. 6 as nodes 715, 720, 725 and 730.

The nodes 715, 720, 725 and 730 correspond to the values 40, 80, 120 and 160 stored in the level 0 memory 700. The corresponding values stored in the level 0 memory 700 are essentially part of the each node in level 0 memory 710. However, the maximum value from each node in level 1 memory is promoted from level 1 memory and stored in level 0 memory 700 as a key value that represents the maximum value of the lower level node. The maximum key values stored in the level 0 memory thus represent the child nodes stored in level 1 memory. The level 0 memory outputs its maximum key values to the search block 740.

The search block 740 receives key data for search and retrieval operations. Upon receiving key data for a search operation, the search block 740 compares the received key data with the maximum key values stored in the level 0 memory. As an illustrative example, the search block shown in FIG. 7 may output the following address value based on the following key data conditions relative to the key entries in level 0 memory:

| | Level 0 Search |
|---|---|
| Key Data | Block Output |
| key data is <= 40 | 00 |
| 40 < key data <= 80 | 01 |
| 80 < key data <= 120 | 10 |
| 120 < key data <= 160 | 11 |

In this manner, the level 0 search block classifies the received key data as having a value that potentially falls within the range of one of the child nodes in the level 1 memory 710. In the example shown in FIG. 7, search block 740 outputs a two bit value that represents an address of the child node within the level 1 memory that has a range of values that may include the key data. Thus 00 identifies node 715; 01 identifies 720; 10 identifies 725 and 11 identifies 730.

The search block 750 receives the values of the key elements in the child node identified by the search block 740 output. The search block 750 also receives the key data and compares the key data with the values received from the level 1 memory identified by the search block 740. The search block 750 then determines whether there is an exact match between the key data and one of the key entries in level 1 memory. The search block 750 may also determine whether there is an exact match between the level 0 memory and the key data or the search block 740 may perform this determination depending on the implementation of the search block and the level 0 and level 1 memories.

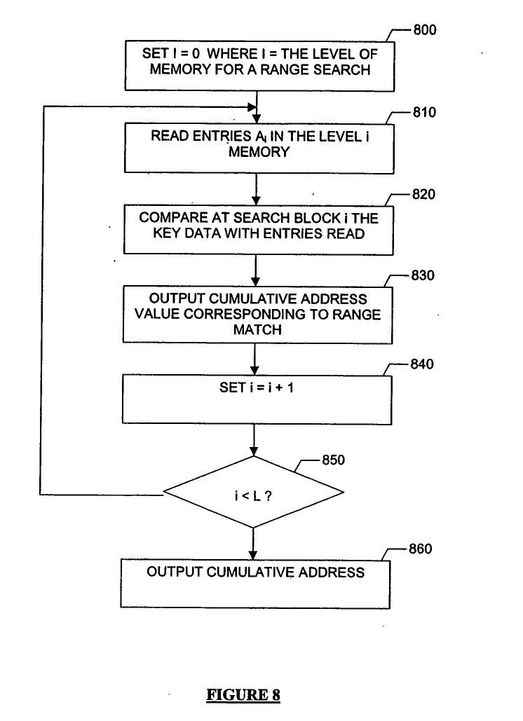

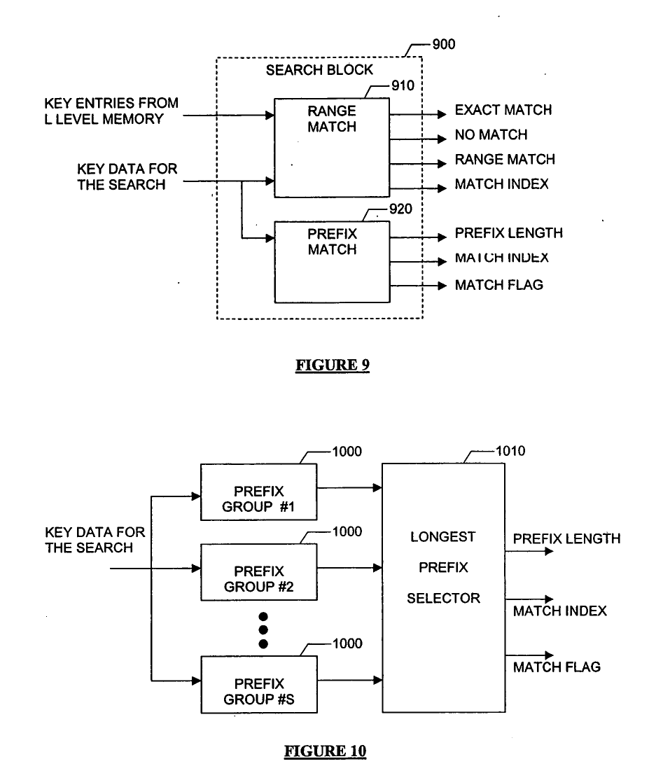

If there is an exact match, the search block 750 outputs the address value received from the search block 740 and adds to it a value representing the position of the matching key entry from the level 0 memory 710. The address value output by the search block 750 may be used as an input to the associated memory 150 to retrieve the data associated with that the matching key entry. As an alternative to exact match, the search blocks may also perform a longest prefix match. This is shown and described in FIG. 9.

The memory and search architecture shown in FIG. 7 corresponds to the two level memory architecture described with reference to FIGS. 2-6. According to an illustrative embodiment, the maximum number of entries in the level 0 memory 700 is generally equal to the number of rows R of the memory described. The values are equal to aᵢ. The value of D is equal to the number of key entries stored within each row R minus 1 because the maximum value is represented in level 0 memory. The entries corresponding to the child nodes in level 0 memory are the row values bi,j stored in each row minus the maximum value (in some embodiments). The maximum value may, however, be retained in each row and may actually used by the search block to determine an exact match or for other purposes even though it is omitted from the illustrative diagram shown in FIG. 7.

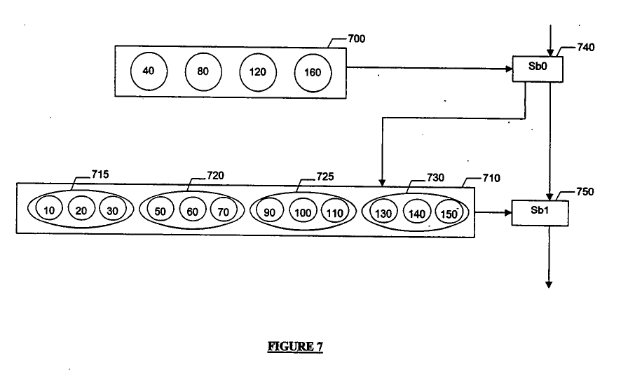

FIG. 8 depicts a method of performing a search operation for a VCAM according to an embodiment of the present invention. Referring to FIG. 8, in step 800, i is set to 0 where i is the first level of memory for a range search within a L level memory. Accordingly, 0<i<L−1. L may have any value depending on how large the memory is and how many levels the memory is implemented as.

In step 810, the search block reads the entries a₁ in the level i memory. In step 820, the search block compares the key data received for searching with the entries read from the level i memory in step 810. Then in step 830, the search block outputs an address value corresponding to the range match determined by the comparison. The value output in step 830 may be a cumulative address value that represents the output of each stage i search block concatenated together.

In step 840, i is set to i+1. Then in step 850, i is checked against L. If i is equal to L then step 860 begins and the cumulative address value is output from the L−1^{st} level search block. This cumulative address value may be used to identify the data stored in the memory 150 that is associated with the key data determined to match the key data during the search. If i is less than L, in step 850, then step 810 begins again with the value of i having been incremented to reflect the next search block level.

The method depicted in FIG. 8 depicts performs an illustrative search method for an L level memory based on L search blocks, such as those shown as sb₀-sb_{L-1} in FIG. 1. It will be understood that the search block stages may be implemented according to the method of FIG. 8 in a pipelined fashion such that search block comparisons of key data with each of the L stages of memory may be performed in successive clock cycles. With each clock, memory cycle, or multiple thereof depending on implementation, new key data may enter the search block Sb0. This key data is compared and transmitted to the 1^{st} level search block. The output address is generated and sent to the 1^{st} level memory. On the next clock cycle, new key data enters the level 0 search block and a new comparison is made in the same manner.

Thus the key data may be latched into each search block on successive memory cycles. The key data ripples through each level of the L level pipeline with successive memory cycles. Comparisons may be made at each search block level i to the i^{th} level memory. At the last search block stage, L−1, the cumulative address is output for the key data that arrived for searching L memory cycles earlier. The cumulative address value, however, may be output every memory cycle (depending on implementation) for the successive key data values received for searching and leads to a search method with high throughput.

Exact Match And Longest Prefix Match Operations

Each search is programmed to determine whether there is either an exact match, a range match or a single prefix match with respect to key data that the search blocks search for within the L level key entry memory.

FIG. 9 depicts a block diagram of an embodiment of a search block. There are many variations of the search blocks that are possible and within a particular VCAM, the search blocks may be different from one another depending on the level of hierarchy that they are implemented at and the particular design implementation.

Referring to FIG. 9, a functional block diagram of an illustrative search block is depicted. The block diagram includes a range match unit 910 and a prefix match unit 920. The range match unit operates as described above with reference to FIGS. 1, 7 and 9. In this regard, the range match unit reads the key entries from the corresponding level of memory that the search block is implemented at. It also reads the key data being searched. The range match unit 910 then generates output signals depending on the particular implementation of the VCAM based on the results of the comparisons made in the range match unit 910. If the key data exactly matches one of the key entries, the range match unit 910 may output an exact match signal. If the key data does not exactly match any of the key entries, the range match unit 910 may output a no exact match signal. These exact match or no exact match signals are optional depending on the implementation and may indicate to other units of the VCAM when and whether an exact match has occurred.

The range match unit may also output a range match signal indicating whether or not the key data is within a range of key entries stored in the particular memory level associated with the search block. The range match unit may also output the match index corresponding to either the range match or the exact match. The match index may identify a portion of the memory that stores the range match, such as the child key entries. Alternatively, the match index may specify an address for the exact match or range match within the associated data memory 150.

An illustrative implementation of a range match unit 910 is shown in FIG. 12. It will be understood that any convenient implementation may be made, however. Referring to FIG. 12, a plurality of comparators 1200 receives the key data, designated k in the figure, and key entries designated eₙ from each entry on a particular memory level. Each comparator is associated with one of n key entries on a particular level of memory and generates a 0 if the key data is less than the key entry and a 1 if the key data is equal to or greater than the key entry. The comparators are arranged in order of value of the key entries. The comparator output may therefore fall into one of the following four categories shown illustratively below for the case where n=5:

00111—the entries are in ascending order

11100—the entries are in descending order

00100—the entries are in cyclical descending order

11011—the entries are in cyclical ascending order

The comparator outputs are sent to a “10” searcher 1210 and a “01” searcher 1220. The “10” searcher outputs a start index to a subtract block 1230 the “01” searcher outputs an end index to the subtract block 1230. The searchers 1210 and 1220 detect transitions from 0 to 1 and vice versa and may be implemented with any convenient logic. The searchers output the bit position of its respective transition. The subtract block determines and outputs the match index according to the following logic:

```
if (end_index > start_index)
    match_index = end_index − start_index;
else
    match_index = (end_index + (n − 1)) − start_index.
```

The prefix match unit 920 may be implemented in addition to the range match circuit in appropriate VCAMs to perform a longest prefix match operation, depending on the desired implementation of the VCAM. The search block may also be used as a building block for longest prefix match by programming it to perform single prefix match. According to this implementation, all the entries associated with the search block have the same prefix length. The longest prefix match operation may be particularly useful in network switching applications which process the IP address information in packet headers. Each prefix bit is related to the output port best adapted to the packet and the longest prefix match provides the most accurate output port assignment for the packet. For such applications, the VCAM may be used to store IP address information and its associated output port information.

The prefix match unit 920 receives the key data for searching and determines the longest prefix match. This information is then output as a prefix length signal and a match index signal. The prefix length signal identifies or relates to the length of the longest prefix that matched the key data. The match index signal identifies the location of the matching prefix within the L level memory. The match index may be an input into the associated data memory to determine the data associated with the longest matching prefix. The prefix match unit 920 may also output a match flag indicating when the match index and prefix length data are valid because one of the prefixes matches a prefix portion of the key data.

FIG. 10 depicts an illustrative implementation of the prefix match unit 920. The prefix match unit may include S prefix group units that are arranged in parallel. There are S prefix group units, where each of the S prefix group units identifies a prefix match for an entry with a particular length. Each prefix group unit receives the key data for the search and outputs a prefix match, when present for a particular prefix of its corresponding length to the longest prefix selector. Each prefix group also outputs a match flag when a prefix match is present for the prefix group.

The longest prefix selector 1010 receives all of the inputs from the S prefix group units and selects the matching prefix having the longest length. This may be implemented as a binary tree of comparators where each comparator checks the match flag of each of the S prefix group units. If the match flag is a one, each comparator compares the prefix length from the prefix group units at its input and forwards to the next comparator the prefix group output with the longest prefix match among the child nodes. In this manner the longest prefix match is identified from the prefix group units 1000. The longest prefix selector may output the prefix length of the longest prefix match, the match index for the longest prefix matched and a match flag indicating that a match was found. The match index may be taken from the prefix group unit 1000 identified as the winner by the longest prefix selector.

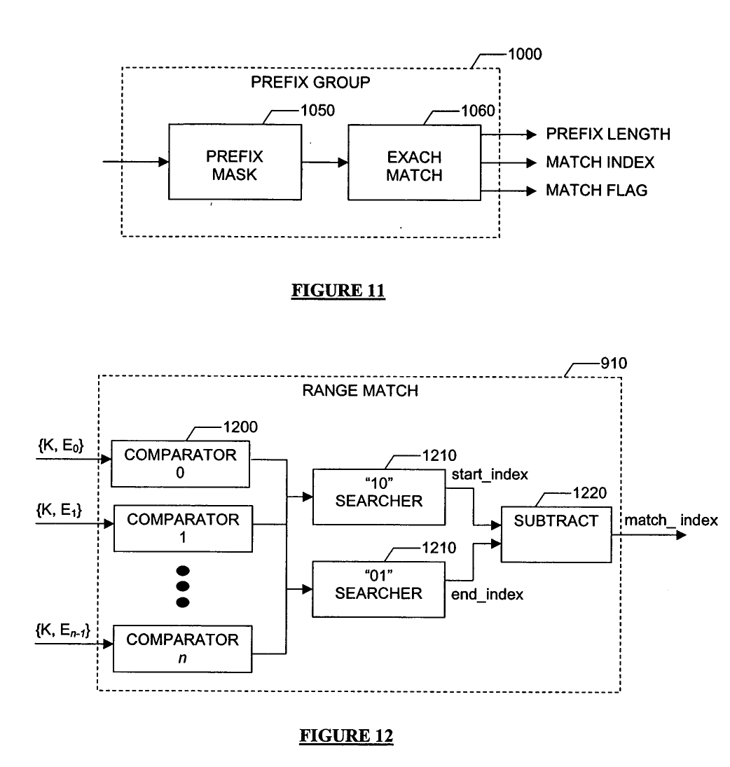

FIG. 11 shows an illustrative implementation of the single prefix match operation of the prefix group unit 1000. The prefix group unit 1000 may include a prefix mask unit and an exact match circuit. The prefix mask unit receives the key data being used for the search and passes the highest order bits of the key data, which is the prefix of the key data, until the prefix length for the particular prefix group has been reached. Therefore, for a prefix group having a prefix length of l, the prefix mask unit 1000 passes the highest order l bits of the key data to the exact match unit 1060. The lower order bits may be set to 0. The prefix mask unit also masks the key entries for the appropriate prefix length in the same manner and passes these values to the exact matcher 1060.

The exact matcher 1060 determines whether there is an exact match between the masked key data and the prefix entries, which all have the same prefix length. If so, the exact matcher 1060 generates a match flag indicating a match was found, a match index corresponding to the matching key entry and a prefix length representative of the prefix group and the masking operations performed. These values are then transmitted to the longest prefix selector 1010 which in turn determines the longest prefix match. Since different kinds of operations like exact match, range match and single prefix match use 910 as a building block, only one 910 has to be implemented in each search block.

The Data Associated With The Key Entries

The data associated with the key entries may be stored and related to the key entries in a variety of ways. For example, the associated data may be stored in a separate memory 150 as shown in FIG. 1. Each key entry may then include its own value and a pointer to the associated data in the associated data memory. Alternatively, the associated data may be stored with the key data in memory. In still other embodiments, the associated data may be stored in a parallel memory that undergoes the same operations as the key data during insertion and deletion to maintain proper association. As another example, the key data values address values may specify pointers which in turn point to the associated data memory. These examples are merely illustrative in nature and those having ordinary skill in the art will understand that any convenient implementation of associating data with the key data may be implemented and is contemplated.

The VCAM according to the present invention may be implemented as part of an integrated circuit chip such as a field programmable gate array (FPGA), an application specific integrated circuit (ASIC) or any other type of chip. In addition, the VCAM may be implemented as a stand alone memory chip using any memory technology desired.

In addition, it will be understood that the two level hierarchical implementation described with reference to FIGS. 2-7 may be implemented as a general L level hierarchical memory in any convenient manner, including by subdividing the maximum value registers 220 into subgroups and storing the maximum value of each subgroup into a higher level of a L level hierarchy. In addition, instead of a maximum value a minimum, middle or other value may be chosen to represent a group of entries. Moreover, there is no limit to the number of levels L and the manner in which key entries from the memory may be represented in the L level hierarchy and exploited by the search operation. The key entries may be arranged and represented in a variety of ways based on power, performance and design considerations and the examples given in this application are illustrative in nature.

While particular embodiments of the present invention have been described, it will be understood by those having ordinary skill in the art that changes may be made to those embodiments without departing from the spirit and scope of the present invention.

What is claimed is:

1. A content addressable memory for finding data associated with key data comprising:
memory having a L level hierarchy for storing key entries in a sorted tree form where L>1 and storing data associated with the key entries;
an update block for inserting new key entries and associated data into the memory and deleting key entries and associated data from the memory while maintaining the sorted tree form of the key entries; and
at least one search block identifying a key entry and associated data that match the key data based on comparisons between the received key data and the key entries in the memory at each level of the hierarchy.

2. The memory according to claim 1, wherein the at least one search block comprises L search blocks, each search block corresponding to a memory level and wherein each search block returns an address value that identifies a subset of the next level of the memory for the search operation of the lower level search block until a matching entry or lack thereof is identified by the lowest level search block.

3. The memory according to claim 1, wherein the search blocks are arranged as a pipeline to receive new key data for search and retrieval operations in successive memory cycles.

4. The memory according to claim 1, wherein the at least one search block is configured to determine an exact match.

5. The memory according to claim 1, wherein the at least one search block is configured to determine a longest prefix match.

6. The memory according to claim 5, wherein the longest prefix match is determined based on masking the key data and key entries for different prefix lengths, determining when an exact match exists for different prefix lengths and selecting the longest exactly matching prefix.

7. The memory according to claim 1, wherein the memory includes rows of key entries arranged in order of key value.

8. The memory according to claim 7, wherein the memory includes rows of key entries arranged in cyclical ascending order.

9. The memory according to claim 7, wherein the memory includes rows of key entries arranged in cyclical descending order.

10. The memory according to claim 7, wherein the memory includes pointers to a maximum and a minimum value of each memory row.

11. The memory according to claim 10, wherein the memory stores a node value for each row that represents each row as a key entry in a higher level of the memory hierarchy.

12. The memory according to claim 11, wherein the node value is the maximum value for each row.

13. The memory according to claim 10, wherein the update block stores key entries displaced by insertion of a new key into the maximum value position of the next sequential row and updates the maximum and minimum value pointers of the next row based on the displacement.

14. The memory according to claim 10, wherein the update block stores key entries displaced by deletion of a key into the minimum value position of the next sequential row and updates the maximum and minimum value pointers of the next row based on the displacement.

15. The memory according to claim 13, wherein the memory includes an update value register and is implemented as a dual port random access memory that performs key entry insertion in three sequential operations performed in parallel.

16. The memory according to claim 14, wherein the memory includes an update value register is implemented as a dual port random access memory that performs key entry deletion in three sequential operations performed in parallel.

17. A method of finding data associated with key data in a content addressable memory comprising:
storing data in a memory having a L level hierarchy for storing key entries in a sorted tree form where L>1 and storing data associated with the key entries; and
searching each level of the L level memory hierarchy based on the key data; and
identifying a key entry and associated data that match the key data based on the searching at each level of the L level memory hierarchy.

18. The method according to claim 17, searching is performed as a pipeline for implementing search and retrieval operations in successive memory cycles.

19. The method according to claim 17, wherein the identifying identifies an exact match between the key data and one of the key entries.

20. The method according to claim 17, wherein the identifying identifies a longest prefix match between the key data and one of the key entries.

21. The method according to claim 20, wherein the longest prefix match is determined based on masking the key data and key entries for different prefix lengths, determining when an exact match exists for different prefix lengths and selecting the longest exactly matching prefix.

22. The method according to claim 17, wherein the memory includes rows of key entries arranged in order of key value.

23. The method according to claim 22, wherein the memory includes rows of key entries arranged in cyclical ascending order.

24. The method according to claim 22, wherein the memory includes rows of key entries arranged in cyclical descending order.

25. The method according to claim 22, wherein the memory includes pointers to a maximum and a minimum value of each memory row.

26. The method according to claim 25, wherein the memory stores a node value for each row that represents each row as a key entry in a higher level of the memory hierarchy.

27. The method according to claim 26, wherein the node value is the maximum value for each row.

28. The method according to claim 22, further comprising
inserting a new key entry and associated data into the memory, the insertion row being determined based on the value of the key entry;
moving a key entry displaced out of the insertion row into the maximum value position of the next sequential row; and
updating the maximum and minimum value pointers of the insertion row based on the displacement.

29. The method according to claim 22, further comprising
deleting a key entry and associated data from the memory at a deletion row;
moving a key entry from the next sequential row into the minimum value position of the deletion row; and
updating the maximum and minimum value pointers of the deletion row based on the displacement.

30. The method according to claim 28, wherein the memory includes an update value register and is implemented as a dual port random access memory that performs key entry insertion in three sequential operations performed in parallel.

31. The method according to claim 29, wherein the memory includes an update value register and is implemented as a dual port random access memory that performs key entry deletion in three sequential operations performed in parallel.
